(19) United States
(12) Patent Application Publication
(10) Pub. No.: US 2012/0185392 A1
(43) Pub. Date: Jul. 19, 2012

(54) METHOD AND APPARATUS FOR DONATING MONEY TO A CANDIDATE OR ORGANIZATION

(76) Inventors: Dennis Hubbs, Washington, DC (US); Darrin Auito, Washington, DC (US); Derek Auito, Washington, DC (US)

(21) Appl. No.: 13/352,335

(22) Filed: Jan. 17, 2012

Related U.S. Application Data
(60) Provisional application No. 61/432,653, filed on Jan. 14, 2011.

(51) Int. Cl. G06Q 40/00

(52) U.S. Cl. 705/44; 705/39

(57) ABSTRACT

A method of donating money to a political candidate or organization using a credit card, and a system of networked computers, comprising: using a credit card to make a purchase, transferring purchase amount information and purchaser information electronically to a central computer 12, adding money to a purchaser's donation account by the central computer 12 by using the purchase amount information and purchaser information, determining by a purchaser's donation preferences by looking up the purchaser's donation preferences in a computer database, determining if the purchaser's donation preferences can be legally executed, executing the instructions set in the purchaser's donation preferences, if the purchaser's donation preferences can be legally executed.

### PRIORITY

This application claims the benefit of priority of U.S. Provisional Application 61/432,653, filed on Jan. 14, 2011, the contents of which are incorporated by reference.

### BACKGROUND

The following description sets forth the inventor's knowledge of related art and problems therein and should not be construed as an admission of knowledge in the prior art. Applicants incorporate by reference, U.S. application Ser. No. 12/219,272.

Raising and donating money is as old as politics and campaigning itself. In addition to the “old fashioned” way of political fundraising—making calls, direct mailings, and holding fundraiser events (e.g., town hall events, dinners, etc.), modern campaigns are also raising money online (e.g., online donation button on a webpage) in order to target a wider audience and a greater number of small donations. One drawback to accepting credit card donations is that the services that allow an organization to accept online credit card contributions typically charge transaction fees (e.g., 3-10%) that are subtracted from the top of the donation. Another drawback is that it requires individuals to enter their personal credit card information into a third party website, which can make donors feel unsafe and thereby less likely to donate.

Regardless of the fundraising method being used, and especially in difficult economic times, it is difficult to effectively raise money for campaigns or organizations. Some potential donors, for example, may not have enough disposable income or available resources to donate. And other potential donors may not donate because they perceive, for example, a small donation (e.g., $5.00) as not being worth the time and effort of writing a check and/or entering their credit card information into a website. Ultimately, this leads to less money being raised by the candidate or organization and a feeling of being less involved (e.g., in the democratic process) by the person wishing to donate, but not ultimately doing so.

### SUMMARY

The present invention reduces some of the aforementioned barriers to entry in fundraising, especially political fundraising. For example, an embodiment of the present invention allows a consumer to donate revenues earned from contributions received from his/her credit card issuer (e.g., similar to an “affinity” credit card) to one or more affiliated campaigns or organizations at a time of their choosing.

Specifically, an embodiment of the present invention relates to a method of raising funds through a financial transaction system. For example, a method of donating money to a political candidate or organization using a credit card, and a system of networked computers, the method includes, using a credit card to make a purchase, electronically transferring purchase amount information and purchaser information (e.g., name, address, email, age, citizenship, etc.) to a central computer 12, appropriating a predetermined amount of money (e.g., 100 basis points or 1% of the total transaction value) to a purchaser's donation account 20 by the central computer 12 (e.g., based on the purchase amount information and purchaser information), determining a purchaser's donation preferences by looking up the purchaser's donation preferences in a computer database, determining whether the purchaser's donation preferences can be legally executed, and then executing instructions pre-set in the purchaser's donation preferences, if the purchaser's donation preferences can be legally executed.

### BRIEF DESCRIPTION OF THE DRAWINGS

The advantages of the invention will become apparent in the following description taken in conjunction with the drawings, wherein:

FIG. 1 is an example of a networked computing configuration according to a first embodiment;

FIG. 2 is a flowchart illustrating an example of how money is accumulated in a donation account;

FIG. 3A is a flowchart illustrating an example of how money is transferred from a donation account to a candidate account;

FIG. 3B is a continuation of the flowchart in FIG. 3A illustrating an example of how money is transferred from a donation account to a candidate account

FIG. 4A is a flowchart illustrating an example of how a user's donation preferences are set in a computer and recorded in a database;

FIG. 4B is a continuation of the flowchart in FIG. 3A illustrating an example of how a user's donation preferences are set in a computer and recorded in a database;

FIG. 5A is a flowchart illustrating an example of how a determination is made by a computer regarding the legality of a prospective donation;

FIG. 5B is a continuation of the flowchart in FIG. 4A illustrating an example of how a determination is made by a computer regarding the legality of a prospective donation;

FIG. 6 is a diagram of a computer which can be used to implement the processes of the invention; and

FIG. 7 is a block diagram of a computer which can be used to implement the processes of the invention.

### DETAILED DESCRIPTION OF THE DRAWINGS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

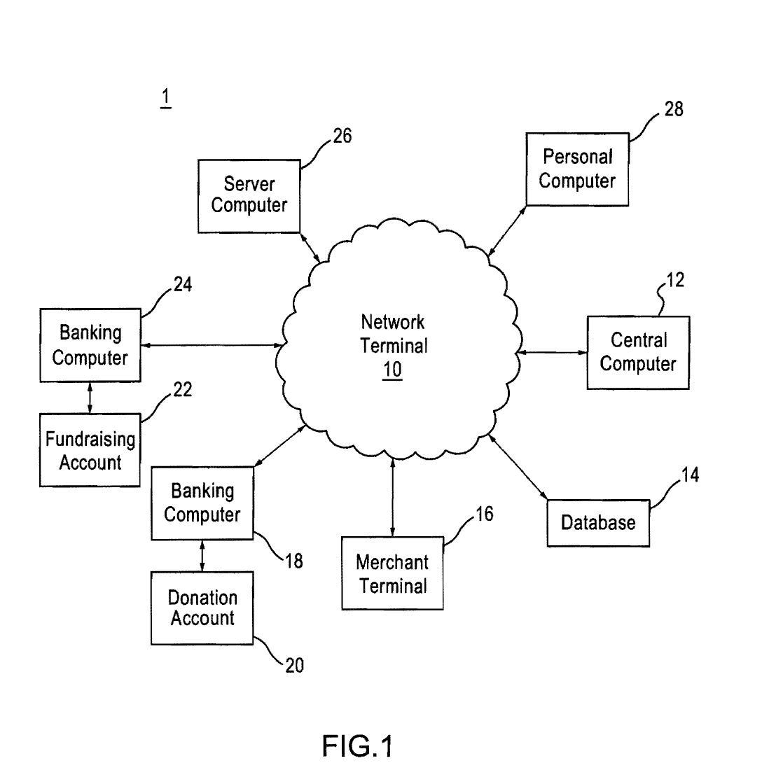

FIG. 1 shows an example of a first embodiment to donate money to a political candidate or organization. A system of networked computers 1 is shown in FIG. 1. As shown in FIG. 1 a network 10, such as the Internet, provides connectivity to a variety of computing devices. A merchant's point of sale (POS) terminal 16 is capable of accepting a credit card or credit card numbers and charging a purchase to the credit card/credit card account. This terminal could be a computer, a cash register, or a mobile credit card reader, etc. Further, the merchant's terminal 16 can communicate to the network 10 to send and receive information to other computers connected to the network 10.

For example, the merchant terminal 16 can communicate with a computer, such as server computer 26 or central computer 12, over the network 10, which authorizes the credit card transaction. The merchant terminal 16 can send a credit card number, a purchaser's name and the prospective purchase amount and other data to and from other computers on the network 10. The terms purchaser, donator, individual, and user are used interchangeably.

A database 14 is shown connected to the network 10. The database 14 can be a freestanding database or can be part of another computer or computer system such as the central computer 12 or the server computer 26. The database 14 can store information regarding the purchaser's credit card information and/or information relating to the purchaser's set donation preferences, discussed in more detail below.

A donation account 20 can be an account which is owned and/or accessible by the purchaser, but maintained and managed by a bank, credit card issuer, third-party provider, or the like. The donation account 20 accumulates contributions (e.g., money) deposited into the account by a banking computer 18, credit card issuer, or the like. The amount of money deposited into the donation account 20 by the card issuer, for example, is determined by the credit card agreement and is referred to as a “contribution amount.” Typically, the contribution amount is determined based on a purchase amount made by the user and/or a number of purchases made by the user. Additionally, the donation account 20 can include money that is separately deposited into the account 20 from a user's own funds. Also, the money deposited into the donation account 20 can be a combination of one or more of the methods discussed above.

For example, if a user makes a $100 purchase with his credit card, a percentage of that transaction amount can be deposited into the purchaser's donation account 20. A typical amount deposited could be 1% of the total purchase price, for example. However, the amount could be more or less than 1%. Further, the amount could vary depending on what was purchased. For example, a user could receive a deposit of 1% of the purchase price deposited into his donation account 20 for purchasing groceries, 2% of the purchase price deposited into his donation account 20 for purchasing gasoline, 3% of the purchase price deposited into his donation account 20 for purchasing sporting tickets, and 4% of the purchase prices deposited into his donation account 20 for purchasing airplane tickets.

The user is not responsible for paying the bank/credit card company for the contribution amount deposited in the donation account 20. The contribution amount is essentially a reward for using the issuer's credit card to make a purchase.

In another embodiment, the contribution amount deposited into the user's donation account 20 is determined based on a number of transactions in which the credit card is used. For example, every time the credit card is used, $0.10 would be deposited into the donation account 20. Thus if the purchaser made 10 purchases with the credit card, $1.00 would be deposited into his donation account.

Again, the user is not responsible for paying the bank/credit card company for the contribution amount deposited in the donation account 20. The contribution amount is essentially a reward for using the credit card to make a purchase.

In another embodiment, a user can contribute his/her own money into his donation account 20 based on any number of factors, such as, for example, aggregated contribution amount deposited into donation account 20, amount of purchase with credit card, number of transactions with credit card, etc.

For example, if the contribution amount totaled $100 in the donation account 20, the user could choose to add $100 of his/her own money to the donation account 20.

A user can use a personal computer 28, such as that shown for example in FIG. 1, in order to access the donation account 20 to set his desired donation preferences. The personal computer 28 shown in FIG. 1 is connected to the network 10 and can access a server computer 26. The server computer 26, for example, allows the user to enter his/her donation preferences and stores the entered preferences in a database 14, which can be part of the server computer 26, the personal computer 28, the central computer 12 (discussed below), or can be a separate memory, such as a cloud based memory.

A second account shown in FIG. 1 represents an individual candidate/organization fundraising account 22. For brevity, this will be referred to this as the candidate account. This account 22, for example, is used by a candidate to accept donations and is typically connected to the network 10 through a banking computer 24 to make sending donations easier with respect to a wire transfer, electronic money transfer, or the like. However this account may not always be able to accept wire transfers, electronic money transfers or the like, and may only accept written checks.

Along with a candidate account 22, a candidate (or organization) contact email address is also available for communication through the internet. This allows the candidate to receive information with respect to the person donating money to his account, the amount donated, the time and date the donation occurred, etc.

Finally, a central computer 12 is shown in FIG. 1. The central computer 12 generally controls the execution of the donation. For example, once a purchase is made with a credit card, the central computer 12 is alerted and sent data with respect to the purchaser and the purchased amount.

The central computer 12 can then determine a purchaser's donation preferences and the legality of the prospective donation and execute the set donation preferences if necessary. This process will be discussed in more detail below.

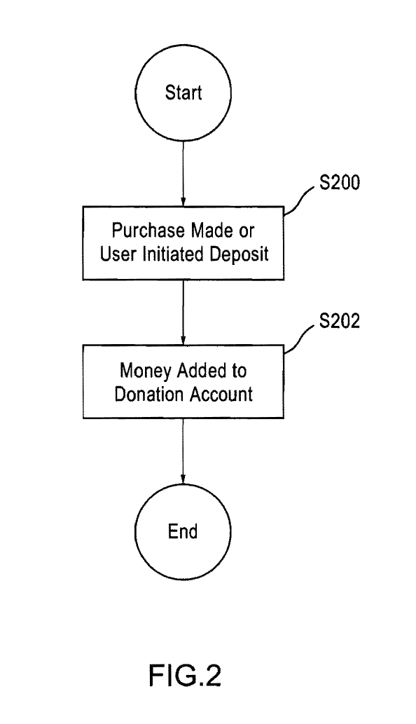

FIG. 2 is a flowchart illustrating an example of how money is accumulated in the donation account 20. In step 200 a user makes a purchase on a credit card. Additionally, a user can add his/her separate funds to the donation account in a user initiated deposit, as described above. In step 202, the contribution amount and/or user initiated deposit is deposited in the donation account 20. The contribution amount may occur before or after the user has paid the credit card bill for the purchase.

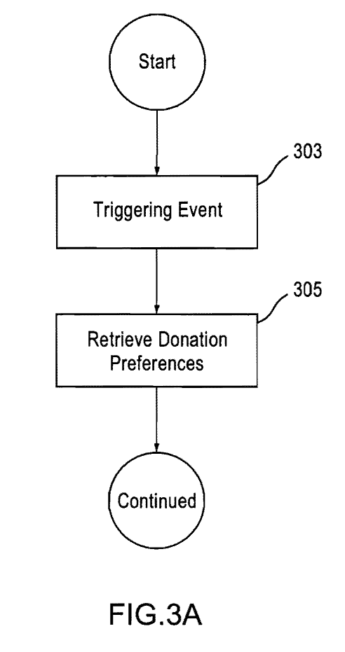

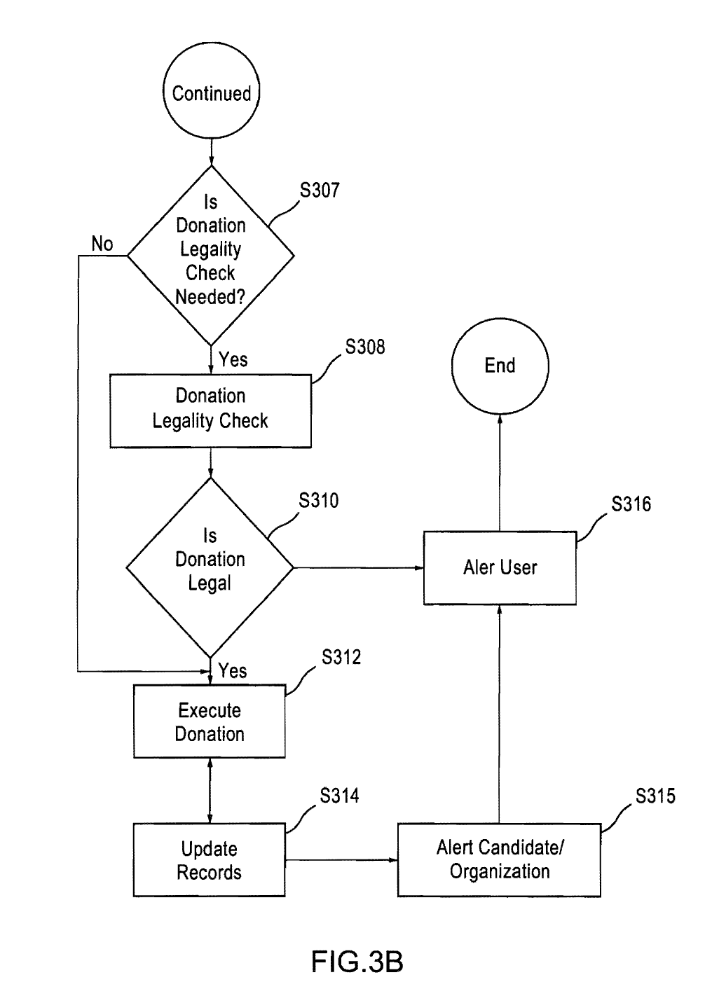

FIG. 3 is a flowchart illustrating an example of how money is transferred from a donation account 20 to a candidate account 22. In step 305, in response to a “triggering event” 303 (e.g., a conditional event, a time event, and/or a physical event, such as a debate, or nomination, as discussed below), the user's donation preferences are retrieved, for example, from the database 14, by the central computer 12, for example. If the user does not set his/her donation preferences, then a triggering event will not occur and money and contribution amounts will continue to accumulate in the user's donation account 20.

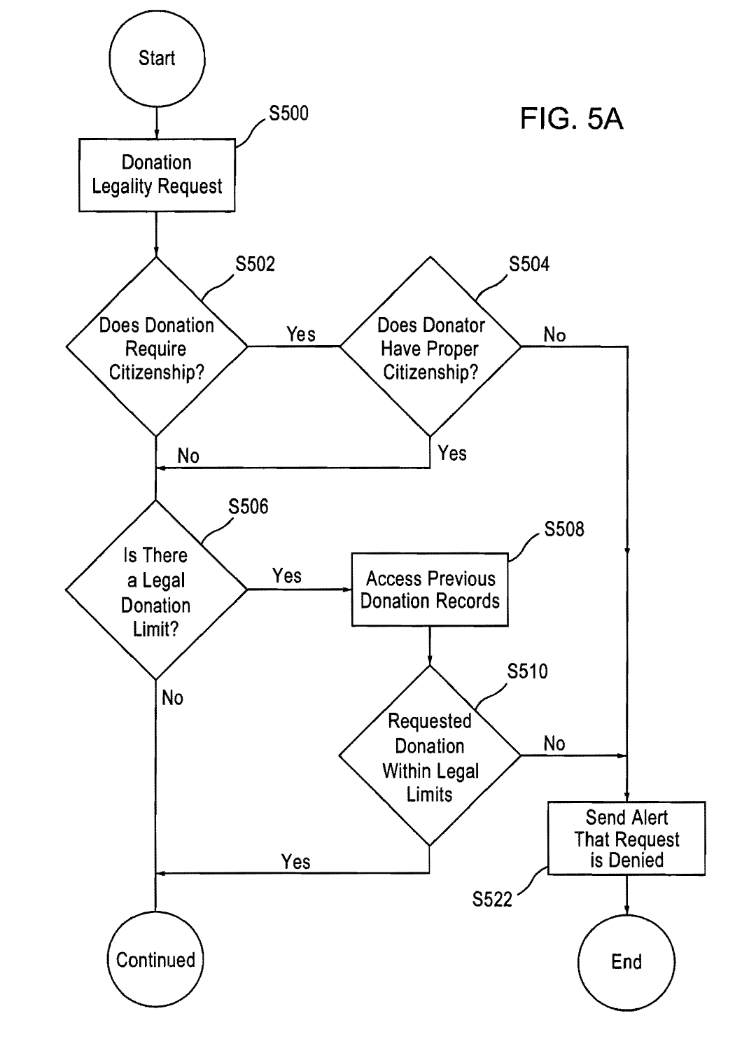

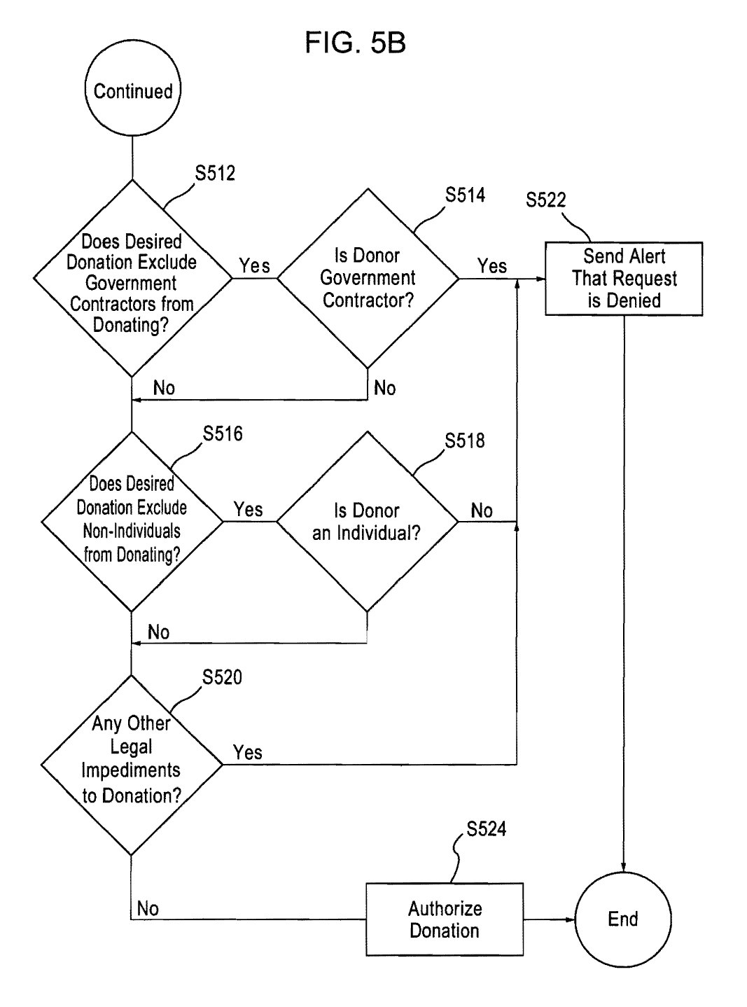

In step 307, the central computer 12, for example, determines whether a donation legality check is necessary. The central computer 12 may be operated by a bank, credit card issuer, or a third-party. Step 307 can be skipped and the donation legality check in step 308 can be performed instead. The donation legality check, step 308, is discussed in further detail below in FIGS. 5A and 5B.

Determining whether a donation legality check is needed can involve whether the prospective donation is political in nature. If the prospective donation is to a candidate or political organization, then a legality check may be needed. Additionally, there may also be other reasons to conduct a legality check, depending on the nature of the parties involved.

In step 310, if the central computer 12, for example, determines that the donation is legal (e.g., complies with local and federal laws), then the central computer 12 executes the donation in step 312.

Step 312 could involve electronically wiring money to the candidate account 22, mailing a check to the candidate account 22, or any other method of transferring money from one account to another account that is previously agreed to between the parties.

In step 310, if the central computer 12, for example, determines that the donation is illegal, then the central computer 12 in step 312 does not execute the donation and alerts the user that the donation cannot be legally executed in step 316.

Once the donation is executed and money is transferred from the donation account 20 to the candidate account 22, the user's records are updated in step 314 (and stored in database 14), and the candidate to whom the donation was transferred to is notified of the donation amount, the name of donor, etc. in step 315 (and a record of such is stored in database 14). The candidate can also be notified of the donor's address, occupation, voter registration, voter district, past donation amounts, etc. The donor is then notified of the donation in step 316 (and a record of such is stored in database 14) and the central computer 12 returns to standby for a triggering event to occur.

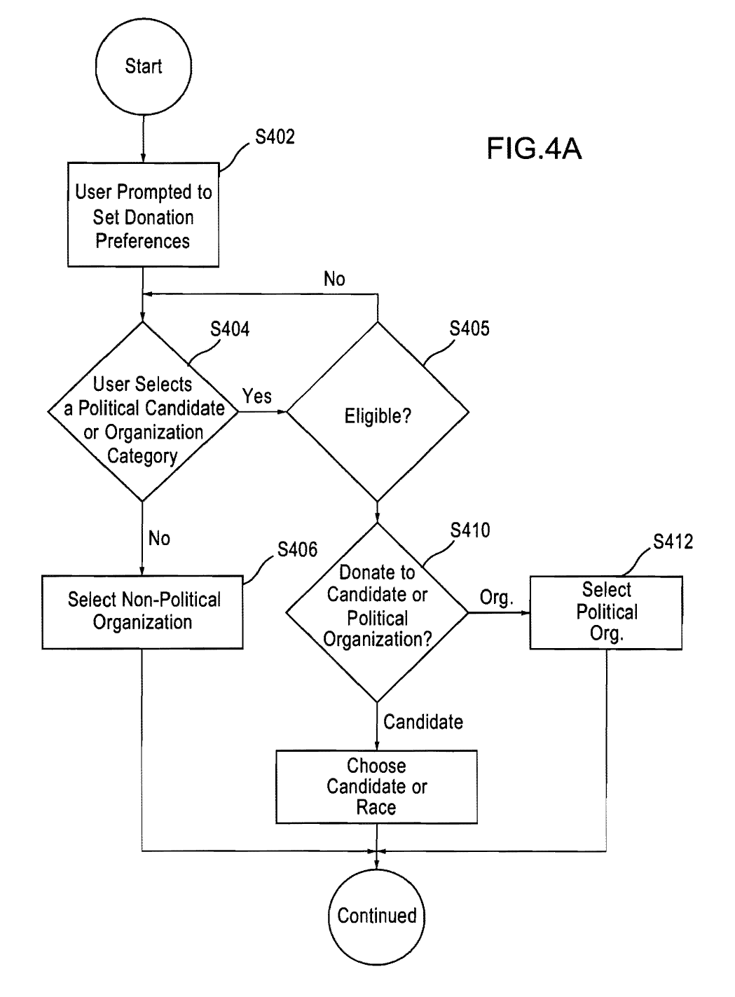

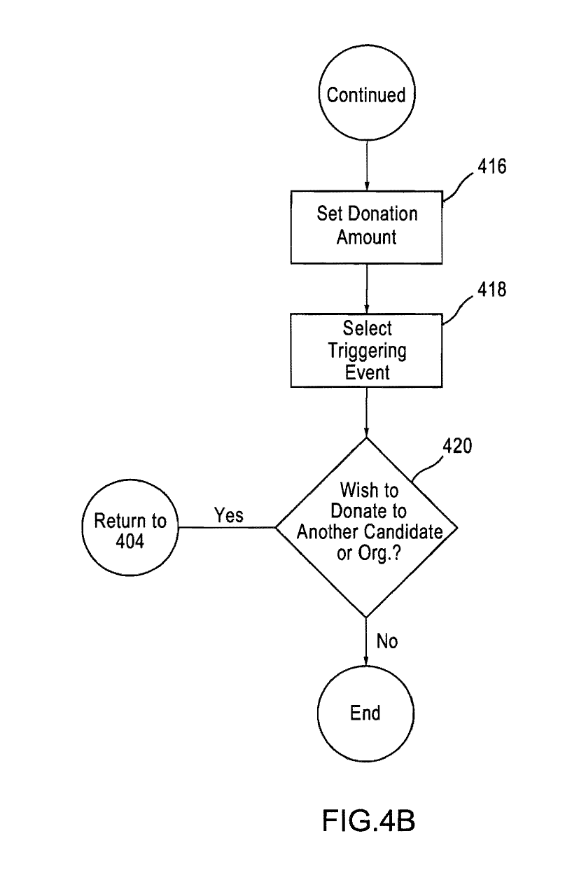

FIGS. 4A and 4B are flowcharts illustrating an example of a process by which the user selects his/her donation preference(s) via a personal computer 28 connected to at least one of a server computer 26 or a central computer 12 running a user preference program, via the network 10. The central computer 12 guides the user through the donation preferences setting process. For example, the user could log onto a secure website/webpage that is linked to donation account 20 via network 10 and hosted on central computer 12 or server computer 26. The secure website contains previously stored personal information related to the registered/authorized user, e.g. contact information, citizenship, employment information, etc. For example, when signing up for a credit card, the user may use a personal computer 28 or the like to input his/her donation preferences on the secure website regard to how funds accumulated in his/her donation account will be dispersed. This is called the user's donation preferences. The user can opt to share some of his/her stored personal information with other website users.

The webpage may also include information regarding the donation preferences and personal information of other users. In step 402, the user is prompted by the central computer 12 to set his/her donation preferences. The user preferences would then be saved in a database 14 which is accessible to, for example, the central computer 12.

As explained above, if the user does not input his/her donation preferences, then any money accumulated in his/her donation account 20 would accumulate until the user sets his/her donation preferences and the desired triggering event occurred.

The user's donation preferences could be implemented in several ways. For example, some or all of the steps shown in FIGS. 4A and 4B can be followed to help set a user's donation preferences.

As shown in FIG. 4A, once a user decides to input his donation preferences, the user must then determine if he wants to donate to a candidate or an organization as shown in step 404. A candidate may include, for example, a politician running for re-election, or a non-incumbent seeking political office. An organization may include, for example, a political organization such as the Republican National Committee™ (RNC) or Democratic National Committee™ (DNC). Further, an organization could also include a non-political organization such as Habitat for Humanity™ or the Red Cross™, academic organization, international organization, etc.

In step 408 the central computer 12 determines the user's eligibility with respect to donating to political candidates or organizations. This step is optional. This can be done by looking up the user's personal information, which is stored in database 14. Eligibility is approved or denied by the central computer 12. If the desired donation is to a non-political organization, then the central computer 12 prompts the user to select/enter the desired organization in step 406. The selection process could involve using filtering-type, drop-down menus, political party, district maps, keyword search, manually entry, etc.

If the desired donation is to a political candidate or organization and the user is eligible to donate to a political candidate or organization, the central computer 12 prompts the user to select between donating to a desired candidate or political organization in step 410. If the user chooses to donate to a political organization in step 412, the method of selecting the political organization is like that described in step 406.

If the user chooses to donate to a political candidate in step 414, the central computer 12 can guide a user to a desired race/candidate via filtering-type drop-down menus, district maps, keyword search, manual entry, political party etc. The central computer 12 could also recognize the user's location and could inform the user of candidates involved in races in his/her election districts.

Once a user has completed step 414, the user is prompted to enter the amount of money he/she wishes to donate from his donation account in step 416. The user could indicate to donate as much as all of the money in the donation account 20, or as little as a single penny. As mentioned above, if the user has chosen to set up a reoccurring donation, the user could set a constant rate of donation, or a varying rate of donation.

For example, a user could choose to set his/her donation amounts for an increasing level as time progresses. The first month, a donation of $5 could be made, the second month a donation of $10 could be made, the third month a donation of $50 could be made, etc.

A user could also choose to set up a decreasing amount of money to be donated. For example, during a primary election a donation of $100 could be made and during a general election a donation of $50 could be made.

A user could also elect to donate a certain percentage of money accumulated in his/her donation account 20 to one or more candidates.

Additionally, as an optional way of double-checking the legality of the prospective donation, according to federal, state and local rules, a user would only be allowed to donate a legal amount to a particular candidate or organization. A user could not set his donation preferences to make a donation larger than that allowed by law.

Further, if the user wished to donate to a political candidate or organization, only legal donation preferences would be allowed to be entered by the personal computer 28 which is in communication with the server computer 26 or central computer 12. For example, if a foreign national wished to set his donation preferences to donate money to the President of the United States, he/she would not be allowed to do so.

A user could also make reoccurring donations to a particular candidate for example, until the user had reached the maximum limit allowed by the law.

In step 418 the user is prompted to enter a conditional event, time event or physical event in which he/she desires to donate money from his/her donation account 20. This is also referred to as a triggering event (i.e., as discussed above in step 303). Thus, after indicating the non-political organization in which to donate to in step 406, the political organization in which to donate to in step 412, or the candidate in which to donate to in step 414, the user can indicate a specific time frame or event (physical or conditional) which will trigger the donation process from the donation account 20 to the candidate account 22

For example, a user could choose to donate money at a particular time. Choosing when to donate money to a candidate can be just as important as choosing how much money to donate. For example, donating money in the beginning of a candidacy could be extremely important to a candidate viewed as having little chance at winning the nomination or election. Additionally, the user could set up a reoccurring donation so that a donation is made every week, every month, every year, etc., to a particular entity.

Also, a user may choose to donate money during a primary election or during a general election. The user may choose to donate money after a particular event, such as the nomination or a debate.

Also, a user may choose to donate money upon the occurrence of a conditional event. For example, the user can conditionally decide to donate money after a predetermined number of users or a predetermined donation threshold is reached. Further, a user may wish to choose to donate money only when the user has logged on to his account and indicated such in his donation preferences.

In other words, a user may wish to indicate that no money is to be donated from the donation account 20 until the user has specifically authorized such, at a future time that is yet to be determined. Therefore, the user is given a great deal of flexibility in determining when to donate and how much to donate. This allows the user, if desired, to set up his donation preferences one time, and make numerous donations according to his set donation preferences without having to do anything more than use his credit card.

Once a triggering event(s) is defined by the user in step 418, the user could be asked if he/she wished to donate to an additional candidate or organization, as shown in step 420. If the user wished to set donation preferences for another candidate or organization, the process would repeat and the user would start again at step 404. If the user is done entering candidates/organizations to donate to, the information is saved in a database 14 and the step of entering donation preference would be complete.

A user may also elect to join a community of other users in order to pool individual donations into a collective donation (e.g., defined as individual donations transferred to a predetermined candidate account at the same time). The collective donation can be managed by a user or users (“manager”). The manager may determine a triggering event for the collective donation (e.g., when the resources reach a certain monetary level, at a predetermined time. etc.)

Once the triggering event has occurred; e.g., the particular set point in time was reached, the central computer 12, for example, proceeds to execute the donation process.

The webpage may also include a chart to inform the users of the amount of resources in the collective donation. The webpage allows users to invite other users to participate in the collective donation.

The user would be free to log back into his account and modify his donation preferences at any time.

FIGS. 5A and 5B show examples of an embodiment of a donation legality check. The donation legality check can be conducted by the central computer 12 or by a server computer 26 which the central computer 12 can communicate with. In the depicted embodiment, this check is conducted by server computer 26.

A donation legality check is performed to make sure that every political donation is complies with federal, state, and local laws. The Federal Election Commission (FEC) is the governing body for political campaigns in federal elections. The FEC makes sure that donation laws are adhered to by each campaign and each donor.

In step 500, the server computer 26 receives a request by the central computer 12 to check the legality of the prospective donation by the user.

In step 502, the server computer determines whether citizenship is required to legally make the donation. If citizenship is required, then the server computer 26 determines in step 504 whether the prospective donor has the requisite citizenship. If the prospective donor meets the citizenship requirement or if the donation does not require a particular citizenship (e.g., such as to a non-political organization), the server computer 26 proceeds to step 506. On the other hand, if the prospective donor does not meet the citizenship requirement, the server computer proceeds to step 522 and sends a message to the central computer that the donation request is denied. (If the central computer 12 is performing the donation legality check, then the central computer 12 denies the donation request.)

In step 506, the server computer 26 determines whether there is a legal donation limit. If there is a legal donation limit, the server computer 26 can access the previous donation records of the donor that are stored in database 14, in step 508.

The database 14 stores donation information with respect to the user. The donation information can include each donation contribution the donor has made; the time of each donation; the location of the candidate or organization donated to; the location of the donor at the time of the donation; the office which the candidate was running for; the citizenship of the donor; the occupation of the donor; the legal status of the donor (e.g., corporation, individual, etc.); and other relevant information.

Once the donation records of the donor have been accessed by the server computer 26, a determination is made in step 510 as to whether the prospective donation will exceed the maximum allowable donation to that candidate or organization. The amount of the prospective donation and previous donations may be used, for example.

If the desired donation will exceed a legal limit, the server computer 26 communicates to the central computer 12 that the donation request is denied and the central computer 12 denies the donation request in step 522.

If the desired donation is within the legal donation limits, the server computer 26 proceeds to step 512 to determine whether the prospective donation is subject to restrictions with respect to government contractors. Government contractors are prohibited from making certain political donations to public officials.

If the prospective donation is subject to a restriction from government contractors, the server computer 26 proceeds to step 514 in which it is determined whether the donor is a government contractor. This can be done by using the database 14, discussed earlier. If the donor is not a government contractor, then the server computer 26 proceed to step 516. If the donor is a government contractor, then the server computer 26 communicates to the central computer 12 that the donation request is denied and the central computer 12 denies the donation request in step 522.

As shown in step 516, a determination is made as to whether the desired donation is limited to individual persons. If the desired donation is limited to individual persons, then the server computer 26 proceeds to step 518 to determine whether the donor is an individual person under the law. If the donor is not an individual person (e.g. a corporation), then the server computer 26 communicates to the central computer 12 that the donation request is denied and the central computer 12 denies the donation request in step 522.

If the donor is an individual person, or if the desired donation is not subject to an individual donor require, then the server computer 26 continues to step 520 and determines whether there are any other legal impediments to performing the donation. If there any other legal impediments to performing the donation, then the server computer 26 communicates to the central computer 12 that the donation request is denied and the central computer 12 denies the donation request in step 522.

If there are no other legal impediments to making the desired donation, then the server computer 26 communicates to the central computer 12 that the donation request is authorized and the central computer 12 authorizes the donation request in step 524.

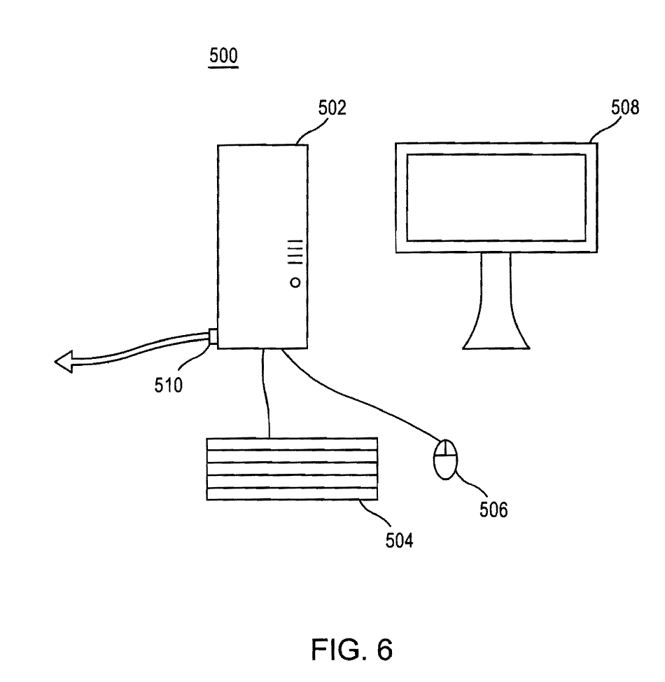

FIG. 6 shows an example of a computer system 500 which includes a computer tower 502, a keyboard 504, a mouse 506, a monitor 508 and an external communication port 510. The computer 500 can be an example of a personal computer 28, a server computer 26, or a central computer 12, as discussed above.

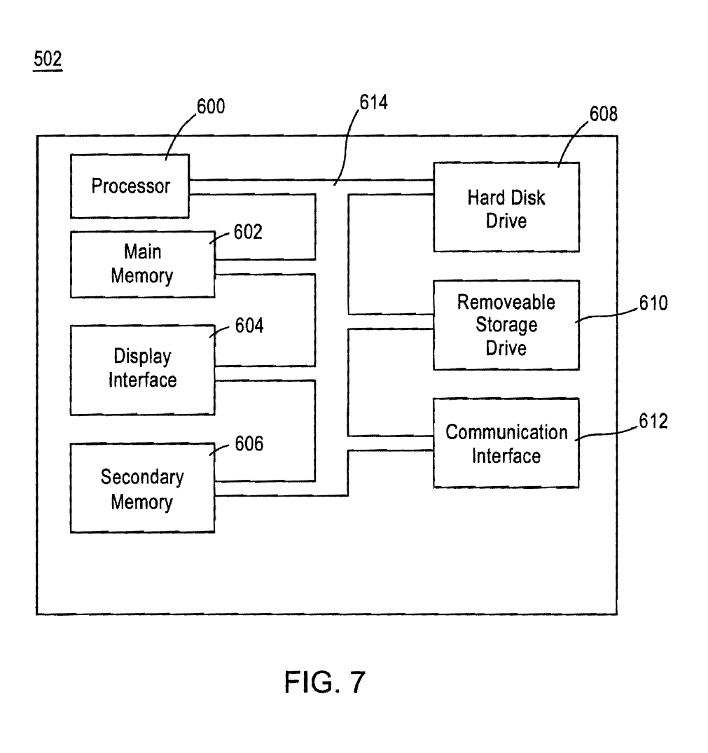

FIG. 7 shows an example of the components inside computer tower 502. The computer 500 can include a processor 600. The processor may be for example an Intel Xenon Processor® or any other processor known to those skilled in the art.

Computer system 500 includes one or more processors, such as processor 600. The processor 600 is connected to a communication infrastructure 614 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 500 can include a display interface 604 that forwards graphics, text, and other data from the communication infrastructure 614 (or from a frame buffer not shown) for display on the display unit 508.

Computer system 500 also includes a main memory 602, preferably random access memory (RAM), and may also include a secondary memory 606. The secondary memory 606 may include, for example, a hard disk drive 608 and/or a removable storage drive 610, representing a floppy disk drive, a magnetic tape drive, an optical disk drive, etc. The removable storage drive 610 reads from and/or writes to a removable storage unit (not shown) in a well known manner. Removable storage unit (not shown) represents a floppy disk, magnetic tape, optical disk, etc. which is read by and written to by removable storage drive 610. As will be appreciated, the removable storage unit (not shown) includes a computer usable storage medium having stored therein computer software and/or data.

In alternative aspects, secondary memory 606 may include other similar devices for allowing computer programs or other instructions to be loaded into computer system 500. Such devices may include, for example, a removable storage unit (not shown). Examples of such may include a program cartridge and cartridge interface (such as that found in video game devices), a removable memory chip (such as an erasable programmable read only memory (EPROM), or programmable read only memory (PROM)) and associated socket, and other removable storage units, which allow software and data to be transferred from the removable storage unit (not shown) to computer system 500.

Computer system 500 may also include a communications interface 612. Communications interface 612 allows software and data to be transferred between computer system 500 and external devices. Examples of communications interface 612 may include a modem, a network interface (such as an Ethernet card), a communications port, a Personal Computer Memory Card International Association (PCMCIA) slot and card, etc. Software and data transferred via communications interface 612 are in the form of signals which may be electronic, electromagnetic, optical or other signals capable of being received by communications interface 612. These signals are provided to communications interface 612 via a communications path (e.g., channel). This channel carries signals and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 610, a hard disk installed in hard disk drive 608, and electro-magnetic signals. These computer program products provide software to computer system 500.

Computer programs (also referred to as computer control logic) are stored in main memory 602 and/or secondary memory 606. Computer programs may also be received via communications interface 612. Such computer programs, when executed, enable the computer system 500 to perform the features of the present invention, as discussed herein. In particular, the computer programs, when executed, enable the processor 600 to perform the features of the present invention. Accordingly, such computer programs represent controllers of the computer system 300.

In an aspect where the invention is implemented using software, the software may be stored in a computer program product and loaded into computer system 500 using removable storage drive 610, hard drive 608 or communications interface 612. The control logic (software), when executed by the processor 600, causes the processor 600 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

The system and method discussed above can be implemented by networked computers, such as that shown in FIG. 1. Furthermore, the computers can be programmed to execute the algorithms discussed above. Additionally, a donation implementation process, as shown in FIGS. 3A and 3B may be implemented by a donation implementation means, as illustrated and described herein. A donation preferences process may be implemented by a donation preferences means, as illustrated and described herein. A donation legality check may be implemented by a donation legality means, as illustrated and described herein.

The donation implementation means, donation preferences means and donation legality check means may be computers which include the hardware shown in FIGS. 6 and 7 along with the proper software and programming needed in order to execute the algorithms.

Below are examples of how the donation method/apparatus could work.

### EXAMPLE 1

A user receives a credit card and sets out to enter his personal information and donation preferences for his donation account 20 into a donation preferences webpage hosted by central computer 12. The user logs on to his donation preferences webpage via personal computer 28 connected to a server computer 26 or central computer 12. The user selects his desired user preferences which include donating to a candidate $100 during the U.S. Senate primary election. The user indicates that the donation is to occur at a certain point in time and that the donation is to be automatically sent to the candidate at that time.

The user then proceeds to use the credit card to make purchases and accumulates money in the donation account, which was deposited by the credit card company based on the amount of money the user spent using the credit card.

Once a triggering event occurs; i.e. the particular set point in time is reached, the central computer 12 proceeds to execute the donation process. The central computer 12 determines that a donation legality check is needed and checks to ensure that the donation is legal. See FIGS. 5A and 5B. Upon determining that the donation is legal, the central computer 12 issues an instruction to wire money to the candidate account 22.

Along with wiring money to the candidate account 22, the central computer 12 also sends the candidate information pertaining to the donation such as the donor's name, the amount of the donation, and any other relevant information needed by the candidate.

### EXAMPLE 2

A user receives a credit card and sets out to enter his personal information and donation preferences for his donation account 20 into a donation preferences webpage hosted by central computer 12. The user logs on to his donation preferences webpage via personal computer 28 connected to a server computer 26 or central computer 12. The user indicates his/her desired user preferences which include setting up a reoccurring donation to a candidate seeking office for the Presidency, every 6 months.

The amount of money to be donated is the total amount of money the user has accumulated in his/her donation account. The user indicates that the donation is to be automatically sent to the candidate at that time without any additional approval by the user.

The user then proceeds to use the credit card to make purchases and accumulates money in the donation account 20, which was deposited by the credit card company based on the amount of money the user spent using the credit card and the number of times the user used the card. Further, the user also elected to match the amount of money deposited by the credit card company. Thus, because $10 was contributed by the credit card company, the user also deposited $10 to his/her donation account, totaling $20.

Once a triggering event occurs; i.e. the particular set point in time of 6 months is reached, the central computer 12 proceeds to execute the donation process. The central computer determines that a donation legality check is needed and checks to ensure that the donation is legal. See FIGS. 5A and 5B. Upon determining that the donation is legal, the central computer 12 issues an instruction to wire money to the candidate account 22.

Along with wiring money to the candidate account 22, the central computer 12 also sends the candidate information pertaining to the donation such as the donor's name, the amount of the donation, and any other relevant information needed by the candidate.

### EXAMPLE 3

A user receives a credit card and sets out to enter his personal information, but does not enter his donation preferences for his donation account.

The amount of money to be donated into the donation account 20 is based on the amount of money the user spent using the credit card and the number of times the user used the card. Thus, money is continuously deposited into the user's donation account 20 over a period of 2 years.

After the user has accumulated $300 in his donation account, he logs into his donation preferences webpage and instructs that $150 be donated to a Congressional candidate.

The central computer 12 then determines that a donation legality check is needed and checks to ensure that the donation is legal. The central computer 12 determines that the donation is not legal because the prospective donor is not a US citizen. The central computer 12 then alerts the donor of the reason why the donation was not executed and the money stays in the user's donation account 20.

While embodiments of the present disclosure have been particularly shown and described with reference to exemplary embodiments thereof, it will be understood by those of ordinary skill in the art that various changes in form and details may be made therein without departing from the spirit and scope of the present invention as defined by the following claims.

1. A method of donating money to a political candidate or organization using a credit card to make a purchase of goods or services, and a system of networked computers, comprising:
a central receiver receiving purchase amount information and purchaser information related to the purchase,
the central computer adding money to a purchaser's donation account based on the purchase amount information and purchaser information,
the central computer determining that a triggering event has occurred in which a purchaser's set donation preferences indicate that money is to be donated to a candidate,
the central computer determining a purchaser's donation preferences by looking up the purchaser's donation preferences in a computer database,
the central computer determining whether the purchaser's donation preferences can be legally executed, and
the central computer executing donation instructions set in the purchaser's donation preferences, if the purchaser's donation preferences can be legally executed.

2. The method of donating according to claim 1, wherein the triggering event is an arrival of a particular date or an occurrence of a particular event.

3. The method of donating according to claim 1, further comprising:
not donating money from the purchaser's donation account based on the set donation preferences.

4. The method of donating according to claim 1, further comprising:
not donating money from the purchaser's donation account based on a determination of illegality.

5. The method of donating according to claim 1, wherein a purchaser sets donation preferences using a personal computer and wherein said donation preferences are saved in a database, said setting donation preferences comprising:
setting a donation preference for a candidate or organization,
setting a citizenship for said purchaser,
setting a timing of the donation,
setting a maximum of money to be donated to said candidate or organization.

6. The method of donating according to claim 5, wherein if the purchaser selects donating to a candidate, setting donation preferences further comprise:
setting either a federal, state or local level of donation, and
setting a desired candidate to donate to at the federal, state or local level.

7. The method of donating according to claim 1, wherein determining if the purchaser's donation preferences can be legally executed, comprises:
determining if the purchaser's desired donation requires a particular citizenship, and
determining if the purchaser's desired donation is subject to a donation limit.

8. The method of donating according to claim 7, wherein determining if the purchaser's donation preferences can be legally executed, further comprises:
determining if the purchaser is a federal government contractor,
determining if the purchaser is an individual.

9. The method of donating according to claim 1, wherein
the database includes a record of users from which to combine individual donations into a collective donation.

10. The method of donating according to claim 1, wherein the central computer 12 contributes the purchaser's own money to the purchaser's donation account, in proportion to the purchase amount.

11. The method of donating according to claim 2, wherein the triggering event is a particular event and the particular event is a candidate winning a primary election.

12. A central computer which donates money to a political candidate or organization based on credit card purchases and donation preferences set by a purchaser, said computer comprising:
a processing unit, and
a database,
wherein after a purchase has been made with a credit card, the central computer transfers money to a donation account,
said central computer then communicates with said computer database to determine is donation preferences have been set.

13. The central computer of claim 12, wherein said processing unit determines if a triggering event has occurred in which a donation is desired to be made by a user.

14. The central computer of claim 1, further comprising:
a donation execution means which determines if a notification event has occurred, wherein said notification event is either a purchase using the credit card or a preset donation preferences event occurring or a preset donation preferences timer triggering situation occurring.

15. The central computer of claim 14, further comprising:
a donation preferences setting means which sets donation preferences including donating to a candidate or an organization.

16. The central computer of claim 15, further comprising:
a donation legality checking means for checking whether or not a desired donation is legal.

17. The central computer of claim 15, wherein said donation legality checking means checks if the desired donation requires US citizenship.

18. A non-transitory computer readable medium for instructing a computer to carry out the steps comprising:
transferring purchase amount information and purchaser information electronically to a central computer,
adding money to a purchaser's donation account by the central computer by using the purchase amount information and purchaser information,
determining that a triggering event has occurred in which a purchaser's set donation preferences indicate that money is to be donated to a candidate,
determining a purchaser's donation preferences by looking up the purchaser's donation preferences in a computer database,
determining if the purchaser's donation preferences can be legally executed,
executing donation instructions set in the purchaser's donation preferences, if the purchaser's donation preferences can be legally executed.

19. The non-transitory computer readable medium according to claim 18, further comprising:
setting donation preferences, wherein said donation preferences are saved in a database, said setting donation preferences comprising:
setting a donation preference for a candidate or organization,
setting a citizenship for said purchaser,
setting a timing of the donation,
setting a maximum of money to be donated to said candidate or organization.

20. The non-transitory computer readable medium according to claim 18, wherein the triggering event is an arrival particular date or an occurrence of a particular event.
